(19) United States
(12) Patent Application Publication
(10) Pub. No.: US 2005/0259246 A1
(43) Pub. Date: Nov. 24, 2005

(54) Apparatus for inspecting a surface and methods thereof

(76) Inventors: Tae-Soo Kang, Seongnam-si (KR); Kyoo-Chul Cho, Yongin-si (KR); Soo-Yeol Choi, Hwaseong-si (KR); Sam-Dong Choi, Suwon-si (KR)

Correspondence Address: HARNESS, DICKEY & PIERCE, P.L.C., P.O. BOX 8910, RESTON, VA, 20195, US

(21) Appl. No.: 11/133,367

(22) Filed: May 20, 2005

(30) Foreign Application Priority Data
May 21, 2004 (KR) 10-2004-0036476

(51) Int. Cl. G01N 21/88

(52) U.S. Cl. 356/237.2; 356/445

(57) ABSTRACT

An apparatus and method for detecting a surface status. The method includes generating first and second pulse sequences and irradiating the first and second pulse sequences into a given surface. Light from the first and second pulses may be scattered by the given surface and analyzed to determine the status of the given surface. The apparatus includes a device for generating pulses which contact a given surface at different incident angles. The light scattered from the pulses may be analyzed at a determining part to determine a status of the given surface. In another embodiment, the method includes generating first and second pulse sequences and adjusting a path of at least a portion of at least one of the first and second pulse sequences such that the first and second pulse sequences are incident upon a given surface at different incident angles.

### PRIORITY STATEMENT

This U.S. non-provisional patent application claims priority under 35 U.S.C. § 119 of Korean Patent Application 2004-36476 filed on May 21, 2004, the entire contents of which are hereby incorporated by reference.

### BACKGROUND OF THE INVENTION

1. Field of the Invention

The present invention relates to an apparatus for inspection and methods thereof, and more particularly to an apparatus for inspecting a status of a surface and methods thereof.

2. Description of the Related Art

A fabrication process for a semiconductor device may include growing or depositing a thin film on a semiconductor substrate and removing a portion of the grown/deposited thin film. The semiconductor substrate may include foreign particles (e.g., contaminants). Further, a surface of the grown/deposited thin film may be recessed (e.g., dented, scratched, etc.). A recession in the grown/deposited thin film may be referred to as a concave defect.

The fabrication process for a semiconductor may include a planarization process (e.g., a chemical mechanical polishing (CMP) process) for planarizing a surface of the deposited/grown thin film. In the CMP process, the surface of the deposited/grown thin film may be polished (e.g., chemically and/or mechanically) to be smoothed or flattened. However, defects (e.g., a scratch, foreign particles, etc.) may occur on the surface of the deposited/grown thin film during the CMP process. Therefore, the fabrication process for the semiconductor may include inspecting the substrate to confirm whether the process is a “dirty process”; namely, whether defects on the substrate may occur during the CMP process.

A conventional method of inspecting a surface of a semiconductor substrate may include the use of laser beams. Laser beams may be irradiated on the surface of the semiconductor substrate. The laser beams scattered (e.g., reflected) from the surface of the semiconductor substrate may be detected and analyzed to inspect for foreign particles and/or other defects on the surface of the semiconductor substrate. The defects formed on the surface of the thin film (e.g., a scratch, a dent, foreign particles on the surface of the thin film, etc.) may include different morphologies.

For example, the foreign particles may be convex defects protruding from the surface of the thin film, the scratch may be a concave defect caved in the surface of the thin film, etc. An incident angle (e.g., an angle between the surface of the semiconductor substrate and the laser beam) of the laser beam selected for defect detection may be determined based on a type of defect (e.g., scratch, foreign particle, etc.).

For the detection of convex defects, the incident angle may be an acute angle. For the detection of concave defects, the incident angle may approximate a right angle. In view of the different incident angles which may be required for defect detection by the conventional methodology, the inspection of the surface of the semiconductor substrate may be executed as separate processes for each of the concave defects and the convex defects.

For example, the laser beam may be projected perpendicularly (e.g., at an incident angle of approximately 90 degrees) to the surface of the semiconductor substrate to inspect for concave defects. The laser beam scatter (e.g., light reflected off the substrate by the laser beam) may then be analyzed to ascertain a number of the concave defects and their corresponding positions.

In another example, the laser beam may have a tilted projection to the surface (e.g., an incident angle less than 90 degrees). The laser beam scatter may then be analyzed to ascertain a number of the convex defects and their corresponding positions. Thus, by the conventional method, the position and the number of concave and convex defects may be obtained only with two separate inspection processes.

However, performing two separate processes for a quality inspection of a semiconductor substrate may increase the duration of the inspection. Further, the separate inspections may cause a redundancy in perceived defects (e.g., duplicate defects). For example, if both of the concave and convex laser beam inspection tests detect the same defect, the result of the inspection process may indicate a duplicate of the detected defect. Defect redundancy may reduce the accuracy of the inspection process.

### SUMMARY OF THE INVENTION

An example embodiment of the present invention is directed to an apparatus for inspecting a surface, including a pulse irradiating part generating a first pulse for a first pulse duration and a second pulse for a second pulse duration, the first and second pulses irradiating a given surface at different incident angles and a determining part determining a status of the given surface based on the first and second pulses.

Another example embodiment of the present invention is directed to an apparatus for inspecting a surface, including a pulse generating part generating a first pulse sequence and a second pulse sequence, the first and second pulse sequences including non-overlapping pulses and an incident angle control part adjusting a path of at least one of the first and second pulse sequences so the first and second pulses are each incident upon a given surface at different incident angles.

Another example embodiment of the present invention is directed to a method of inspecting a surface, including irradiating a first pulse on a given surface for a first pulse duration and at a first incident angle, irradiating a second pulse on the given surface for a second pulse duration and at a second incident angle and determining a status of the given surface based on the first and second pulses.

Another example embodiment of the present invention is directed to a method of inspecting a surface, including generating first and second pulse sequences including non-overlapping pulses and adjusting a path of at least a portion of one of the first and second pulse sequences such that each of the first and second pulse sequences are incident upon a given surface at different incident angles.

### BRIEF DESCRIPTION OF THE DRAWINGS

The accompanying drawings are included to provide a further understanding of the invention, and are incorporated in and constitute a part of this specification. The drawings illustrate example embodiments of the present invention and, together with the description, serve to explain principles of the present invention.

In the drawings:

FIG. 1 illustrates an inspection apparatus according to an example embodiment of the present invention.

FIG. 2 illustrates a waveform of first and second laser pulses having different incident angles at inspecting positions of a target according to another example embodiment of the present invention.

FIG. 3 illustrates an intensity profile of light scattered from a surface of the target by the first and second laser pulses and of FIG. 2.

FIG. 4 illustrates a determining part according to another example embodiment of the present invention.

FIGS. 5 through 7 illustrate a laser pulse generating part according to other example embodiments of the present invention.

### DETAILED DESCRIPTION OF PREFERRED EMBODIMENTS

Hereinafter, example embodiments of the present invention will be described in detail with reference to the accompanying drawings.

In the Figures, the same reference numerals are used to denote the same elements throughout the drawings.

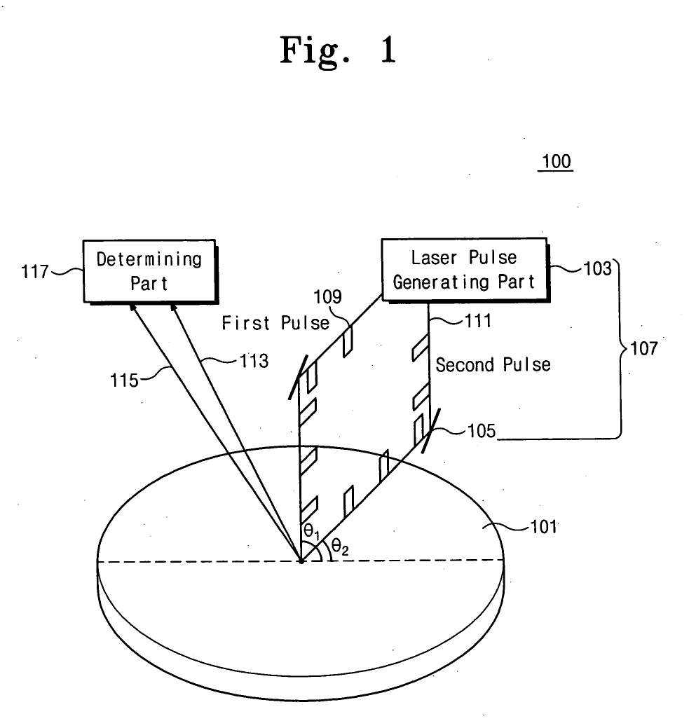

FIG. 1 illustrates an inspection apparatus 100 according to an example embodiment of the present invention. The inspection apparatus 100 may include a laser pulse generating part 103, an incident angle control part 105, a pulse irradiation part 107 and a determining part 117.

In the example embodiment of FIG. 1, the incident angle control part 105 may adjust a path of laser pulses generated at the laser pulse generating part 103. The incident angle control part 105 may adjust an incident angle of the laser pulses irradiated to a target 101. In FIG. 1, the incident angle may refer to an angle formed by a surface of the target 101 and the first and second laser pulses 109 and 111, respectively. In an example, the incident angle control part 105 may include a mirror.

In the example embodiment of FIG. 1, the pulse irradiation part 107 may irradiate laser pulses 109 and 111 to the target 101. In an example, the target 101 may be a wafer (e.g., a semiconductor wafer). The first and second laser pulses 109 and 111 may have different incident angles; namely, a first incident angle θ₁ and a second incident angle θ₂, respectively, as illustrated in FIG. 1. Each of the first and second laser pulses 109 and 111 may be irradiated (e.g., continuously or alternating) into the same position of the target 101 for a given pulse duration (e.g., where the given pulse duration may be the same for each of the first and second laser pulses 109 and 111 or different for each of the first and second laser pulses 109 and 111). A time interval between the first pulse 109 and the second pulse 111 may be referred to as τ₁. A time interval between the second pulse 111 and the first pulse 109 may be referred to as τ₂.

Hereinafter, example embodiments of the present invention will be described with respect to FIG. 1 where the first incident angle θ₁ of the first laser pulse 109 may approximate a right angle and the second incident angle θ₂ of the second laser pulse 111 may be an acute angle (e.g., a lower angle than the incident angle θ₁). For example, the second incident angle θ₂ may be between 10 degrees and 30 degrees. The second laser pulse 111 may be considered to be tilted because of the acute angle of the second incident angle θ₂. The first incident angle θ₁ of the first laser pulse 109 may be suitable for inspecting defects formed in a surface of the target 101. The first incident angle θ₁ may be varied according to a size of the defected portion of the surface. For example, the defects detectable by the first incident angle θ₁ may include a dent, a scratch, etc. The second incident angle θ₂ may be adjusted based on a size of a foreign particle on the surface of the target 101.

In the example embodiment of FIG. 1, a first scattered light 113 and a second scattered light 115 may be generated (e.g., reflected, scattered, deflected, etc.) from substantially the same inspecting position of the target 101 by the first and second laser pulses 109 and 111, respectively. The determining part 117 may determine whether defects occur at the irradiated inspecting position (e.g., from which the first and second scattered lights 113/115 may be reflected/deflected/scattered) of the target 101. The determining part 117 may base the determination of a defect at an inspecting position of the target 101 on two separate types of information (e.g., the scatter of the first and second laser pulses 109 and 111), which may thereby improve a reliability of the inspection.

In another example embodiment of the present invention, while not illustrated in the Figures, at least one of the target 101 and the pulse irradiation part 107 may move so as to inspect an entire surface (e.g., all inspecting positions) of the target 101. In an example, the target 101 may move while the pulse irradiation part 107 remains stationary. In a further example based on the above-given example, the target 101 may be a wafer (e.g., a semiconductor wafer). The wafer may be secured on a wafer chuck (not shown). The wafer chuck may be moved by a stage (not shown) (e.g., moved upward, downward, in a sideways direction, rotationally, etc.). However, it is understood that an inspection of the wafer may be performed in various, alternative ways. In another example, the pulse irradiation part 107 may move while the target 101 remains stationary. In yet another example, both the pulse irradiation part 107 and the target 101 may move during the inspection process.

In the example embodiment of FIG. 1, the laser pulses 109 and 111 may be irradiated to a first inspecting position before the target 101 may be moved to a second inspecting position. For example, the first and second laser pulses 109 and 11 may be irradiated to the first inspecting position at least once. The target 101 may then move. After the target 101 moves, the first and second laser pulses 109 and 111 may be irradiated to a next inspecting position. Similarly, the first and second laser pulses 109 and 111 may be irradiated at least once to the next inspecting position. A period of the first pulse 109 (e.g., a time interval between a current first laser pulse 109 and a next first laser pulse 109) may be referred to as T₁ and a period of the second pulse 111 (e.g., a time interval between a current second laser pulse 111 and a next second laser pulse 111) may be referred to as T₂.

In another example embodiment of the present invention, the time interval between the start of the first laser pulse 109 and the second laser pulse 111 (e.g., time interval τ₁) may be shorter than either of the periods T₁ and T₂. Thus, the condition of the same inspection position being irradiated numerous times by the first and second laser pulses 109 and 111 may be reduced and/or avoided. It is understood that the periods T₁ and T₂ may be the same or different.

In another example embodiment of the present invention, the time interval τ₂ may be shorter than the time interval τ₁. The time difference between the time intervals τ₂ and τ₁ may allow the first and second laser pulses 109 and 111 to be distinguished at different inspecting positions of the target 101. For example, the determining part 117 may distinguish between the first and second scattered lights 113/115 (e.g., scattered/deflected/reflected from the first and second laser pulses 109/111, respectively) based on timing characteristics of the first and second scattered lights 113/115.

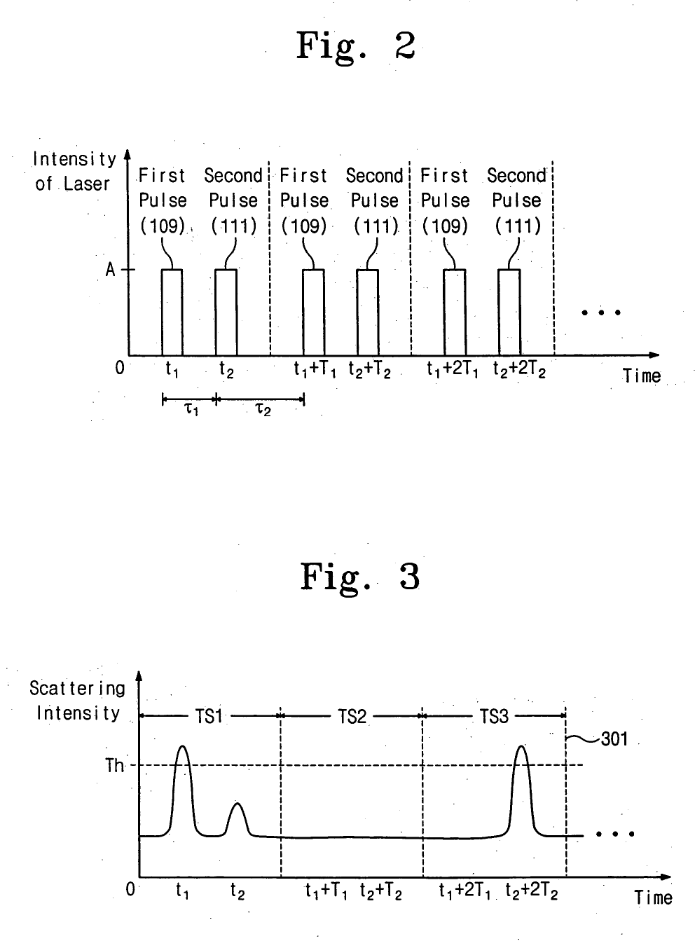

FIG. 2 illustrates a waveform of the first and second laser pulses 109 and 111 having different incident angles at inspecting positions of the target 101. In FIG. 2, a horizontal axis (e.g. X axis) may indicate a time domain and a vertical axis (e.g., Y axis) may indicate a size (e.g., amplitude) of the first and second laser pulses 109/111.

In the example embodiment of FIG. 2, the first laser pulse 109 may be generated at a frequency having a period of T₁ and a second laser pulse 111 may be generated at a frequency having a period of T₂. After the first laser pulse 109 initiates generation, the second laser pulse 109 may initiate generation a given time (e.g., time interval τ₁) later. After the second laser pulse 111 initiates generation, the first laser pulse may initiate generation a given time (e.g., time interval τ₂) later. As illustrated in FIG. 2, the first and second laser pulses 109 and 111 may pulse repeatedly in the above-described manner. In an example, the time interval τ₂ may be longer than the time interval τ₁. In another example, the target 101 may be moved after at least a pair of laser pulses 109/111 may be irradiated to the same inspecting position of the target 101.

In the example embodiment of FIG. 2, the first laser pulse 109 may be projected to a first inspecting position during time t₁. After a first time interval τ₁, the second laser pulse 111 may be projected to the first inspecting position during time t₂. After a first time interval τ₂, the first laser pulse 109 may be projected to a second inspecting position during time t₁+T₁. After a second time interval τ₁, the second laser pulse 111 may be projected to the second inspecting position during time t₂+T₂. After a second time interval τ₂, the second laser pulse 111 may be projected to a third inspecting position during time t+2T₁. After a third time interval τ₁, the second laser pulse 111 may be projected to a third inspecting position during time t₂+2T₂. It is understood that the above-described process may be repeated for any number of inspection positions.

FIG. 3 illustrates an intensity profile of light scattered from a surface of the target 101 by the first and second laser pulses 109 and 111 of FIG. 2. In FIG. 3, a horizontal axis (e.g., X axis) may indicate time and a vertical axis (e.g., Y axis) may indicate an intensity level of the scattered light (e.g., first and second scattered lights 113/115 of FIG. 1). FIG. 3 illustrates results for the three inspecting positions irradiated by the first and second laser pulses in FIG. 2. In FIG. 3, it may be assumed that the first laser pulse 109 may have an incident angle θ₁ which may approximate a right angle (e.g., approximately 90 degrees) and the second laser pulse 111 may have an incident angle θ₂ which may be an acute angle (e.g., less than 90 degrees). In FIG. 3, a value on the Y axis exceeding a threshold intensity Th may indicate a defect at an inspection position of the target 101.

In the example embodiment of FIG. 3, referring to a scattering intensity profile for a period TS1 at the first inspecting position, the scattering intensity (e.g., viewed from the Y axis) may be higher than the threshold intensity Th during time t₁ (e.g., when the first laser pulse 109 may be irradiated to the first inspecting position) and the scattering intensity may be lower than the threshold intensity Th during time t₂ (e.g., when the second laser pulse 111 may be irradiated to the first inspecting position). Referring to a scattering intensity profile for a period TS3 at the third inspecting position, the scattering intensity may be higher than the threshold intensity Th during time t₂+2T₂ (e.g., when the second laser pulse 111 may be irradiated to the third inspecting position). Based on the above-described scattering intensity profile of FIG. 3, the determining part 117 of FIG. 1 may determine that defects (e.g., foreign particles, scratches, dents, etc.) may occur at the first and third inspecting positions (e.g., based on the first laser pulse 109) because the threshold intensity Th may be exceeded. It may further be determined by the determining part 117 that concave defects (e.g., scratches, dents, etc.) may occur at the first inspecting position because the scattering intensity for the first laser pulse 109 may exceed the threshold intensity Th and the scattering for the second laser pulse 111 does not exceed the intensity threshold Th. The determining part 117 may also determine that convex defects (e.g., foreign particles) may occur at the third inspecting position because the scattering intensity for the second laser pulse 111 may exceed the threshold intensity Th.

In the example embodiment of FIG. 3, if a concave defect (e.g., a scratch) at the first inspecting position is smaller (e.g., below a size threshold), the scattering intensity profile for the second laser pulse 111 having an acute angle (e.g., the scattering intensity profile for the second laser pulse 111 may have no peaks).). However, the scattering intensity profile for inspecting portion TS1 corresponding to the first laser pulse 109 (e.g., approximating an incident angle of 90 degrees) may have a peak higher than the threshold intensity Th. Accordingly, a detection reliability of an inspection process using both the first and second laser pulses 109/111 may be increased.

In another example embodiment of the present invention, if neither peak associated with first and second laser pulses 109/111 in a given inspecting portion of a scattering intensity profile exceeds the threshold intensity Th, then no defect (e.g., neither convex nor concave defects) may be detected for the given inspecting portion.

In another example, if a moving speed of the target 101 and an irradiation time (or period) of the first and second laser pulses 109/111 are changed, the first laser pulse 109 and the second laser pulse 111 may each be irradiated more than once at the same inspecting position. In this example, referring to FIG. 3, a peak exceeding the intensity threshold in the scattering intensity profile may occur at least once for the same inspecting position (e.g., if the inspecting position has at least one defect). The neighboring inspecting positions (e.g., the inspecting positions analyzed before and after the over-analyzed inspecting position) may be distinguished by taking the movement of the target 101 and the projection time (or period) of the first and second laser pulses 109/111 into account (e.g., at the determining part 117 of FIG. 1). The reliability of the scattering intensity profiles illustrated in FIG. 3 may thereby be increased because duplicate defects may be removed from consideration.

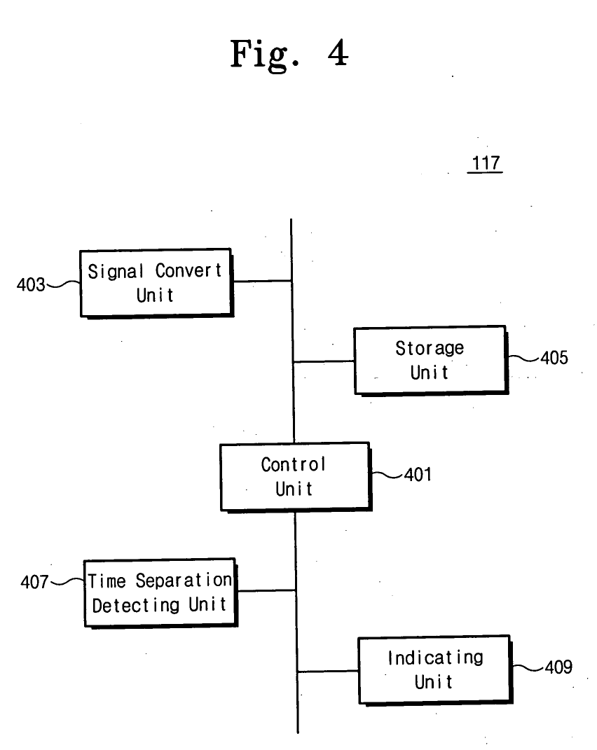

FIG. 4 illustrates the determining part 117 of FIG. 1 according to another example embodiment of the present invention. In the example embodiment of FIG. 4, the determining part 117 may include a signal convert unit 403, a control unit 401, a storage unit 405, a time separation detecting unit 407, and an indicating unit 409. Referring again to FIG. 1, the control unit 409 may control a movement of the target 101 and/or the incident angle control part 105.

In the example embodiment of FIG. 4, the signal convert unit 403 may detect light scattered from a surface of the target 101 (e.g., the first and second scattered lights 113/115 of FIG. 1) and may convert the detected scattered light into an electrical signal. The converted electrical signal generated at the signal convert unit 403 may be stored in the storage unit 405.

In the example embodiment of FIG. 4, the time separation detecting unit 407 may process the converted electrical signal to determine whether defects may be present on a surface of the target 101. The time separation detecting unit 407 may also send the converted electrical signal to the indicating unit 409 to be displayed (e.g., to a user). The time separation detecting unit 407 may divide the scattering intensity profiles into, for example, inspection periods TS1, TS2, and TS3 as shown in FIG. 3, where each of the inspection periods include information associated with a pair of first and second laser pulses 109/111. The time separation detecting unit 407 may confirm whether the scattering intensity profile may include peak values exceeding an intensity threshold (e.g., the intensity thresholds Th of FIG. 3) in each inspecting period (e.g., inspecting periods TS1/TS2/TS3). If the scattering intensity profile includes a peak value exceeding the intensity threshold Th in a given inspecting period, the time separation detecting unit may determine that defects may be present in the inspecting position of the target 101 associated with the given inspecting period.

Alternatively, in another example embodiment of the present invention, a user may visually determine whether a defect may be present in the inspecting position of the target 101 through an analysis of the scattering intensity profile (e.g., as shown in FIG. 3) displayed on the indicating unit 409. The indicating unit 409 may display vertical separation lines 301 for separating sections of the scattering intensity profile to distinguish between inspecting periods (e.g., TS1, TS2, and TS3 of FIG. 3).

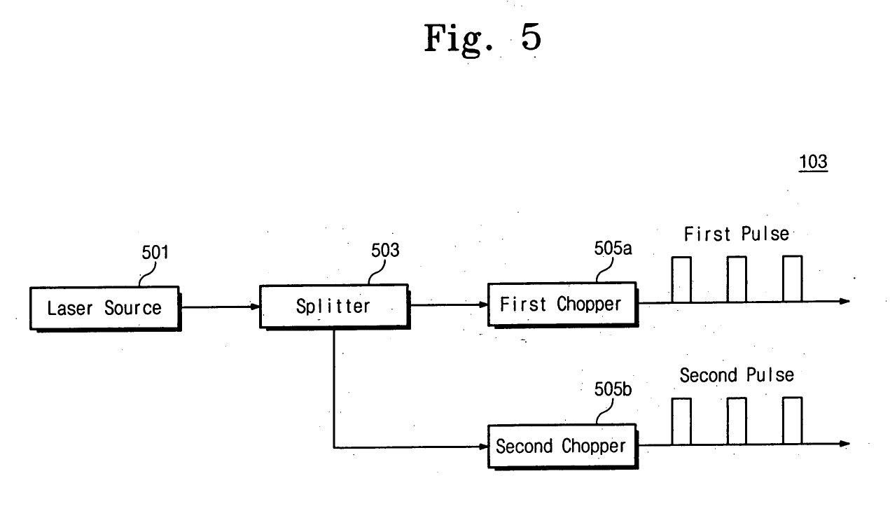

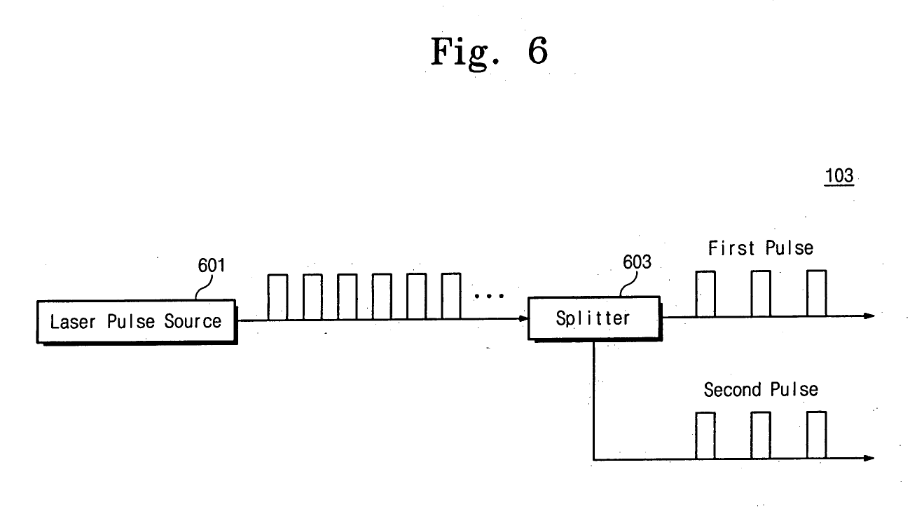

FIGS. 5 through 7 illustrate the laser pulse generating part 103 of FIG. 1 according to other example embodiments of the present invention.

In the example embodiment of FIG. 5, the laser pulse generating part 103 may include a laser source 501, a splitter 503, a chopper 505a and a chopper 505b. The laser source 501 may generate a laser beam. The splitter 503 may divide the laser beam generated at the laser source 501 into two laser beams having different paths. The splitter 503 may be any type of well-known splitter capable of dividing the laser beam (e.g., a Glan-Foucault prism, a Rochon prism, etc).

In an example, where the splitter 503 may be the Glan-Foucault prism, the splitter 503 may pass one of the incident, divided laser beams and may reflect the other of the incident, divided laser beams, thereby generating two separate laser beams with different paths.

In another example, where the splitter 503 may be the Rochon prism, the splitter 503 may divide the incident laser beam into two laser beams with different paths and may pass each of the two laser beams.

In the example embodiment of FIG. 5, the first chopper 505a may sample one of the two laser beams received from the splitter 503 to generate a first laser pulse (e.g., first laser pulse 109) at a given frequency having a period T₁. The second chopper 505b may sample the other of the two laser beams received from the splitter 503 to generate a second laser pulse (e.g., second laser pulse 111) at a given frequency having a period T₂. The first and second laser pulses may be generated for given pulse durations (e.g., where the pulse duration for the first laser pulse may or may not be equal to the pulse duration of the second laser pulse) In another example, the first and second laser pulses may be generated so as to alternate. In yet another example, the incident laser control part 105 of FIG. 1 may adjust the paths of the first and second laser pulses to control incident angles for the first and second laser pulses upon the target 101.

In the example embodiment of FIG. 6, the laser pulse generating part 103 may include a laser pulse source 601 and a splitter 603. The laser pulse source 601 may generate a laser pulse sequence with pulses at a frequency having a given period (e.g., shorter than periods T₁ and/or T₂). The splitter 603 may divide the laser pulse sequence received from the laser pulse source 601 into a first laser pulse sequence and a second laser pulse sequence (e.g., including first and second laser pulses 109/111, respectively) where each of the first and second laser pulses sequences have a different path.

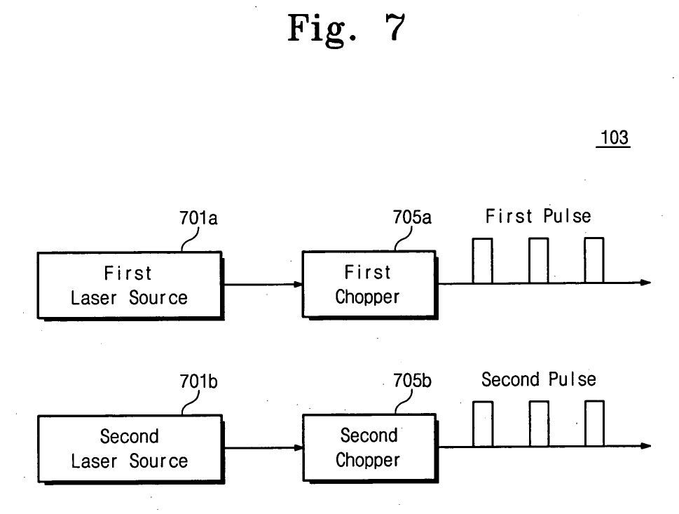

In the example embodiment of FIG. 7, the laser pulse generating part 103 may include a first laser source 701a, a second laser source 701b, a first chopper 705a and a second chopper 705b. The first laser source 701a and the second laser source 701b may generate a first laser beam and a second laser beam, respectively. The first chopper 705a may sample the first laser beam received from the first laser source 701a to generate a first laser pulse sequence (e.g., including laser pulse 109) having a period T₁. The second chopper 705a may sample the second laser beam received from the second laser source 701b to generate a second laser pulse sequence (e.g., including second laser pulse 111) having a period T₂. In an example, the first and second laser pulses sequences generated by the first and second choppers 705a/706a may not overlap (e.g., the second chopper 705b may generate the pulses of the second laser pulse sequence between pulses of the first laser pulse sequence).

In another example embodiment of the present invention, different types of defects (e.g., a convex defect, a concave defect, etc.) may be inspected with a single inspecting process, thereby reducing an inspection process time.

In another example embodiment of the present invention, a reliability of inspection may be increased because the inspection may be based on two types of information (e.g., laser pulses at different incident angles).

In another example embodiment of the present invention, redundant or duplicate defects may be reduced because a determining part (e.g., determining part 117) may take a movement of a target (e.g., target 101) and/or the first and second laser pulse sequences into account when determining whether to consider duplicate defects in a scattering intensity profile.

Example embodiments of the present invention being thus described, it will be obvious that the same may be varied in many ways. For example, while example embodiments of the present invention have been described above with respect to inspection of a surface of a semiconductor substrate, it is understood that other example embodiments of the present invention may be applied in any technical area requiring a surface inspection. Further, while above-described example embodiments employ laser beams and/or laser beam pulses, it is understood that any type of light, ray or other projection capable of reflection/deflection/scatter may be used in other example embodiments for detecting surface defects. Further, while above-described example embodiments employ pairs of pulses (e.g., first and second pulses 109/111) and pairs of pulse sequences, it is understood that other example embodiments of the present invention may employ two or more pulses (e.g., where each of the two or more pulses may be irradiated to a given surface at difference incident angles) and/or two or more pulse sequences (e.g., where each of the two or more pulse sequences may include the same and/or different periods, pulse durations, etc.).

Such variations are not to be regarded as departure from the spirit and scope of example embodiments of the present invention, and all such modifications as would be obvious to one skilled in the art are intended to be included within the scope of the following claims.

1. An apparatus for inspecting a surface, comprising:
a pulse irradiating part generating a first pulse for a first pulse duration and a second pulse for a second pulse duration, the first and second pulses irradiating a given surface at different incident angles; and
a determining part determining a status of the given surface based on the first and second pulses.

2. The apparatus of claim 1, wherein the first and second pulses are laser pulses.

3. The apparatus of claim 1, wherein the determining part determines the status based on a first scattered light and a second scattered light, the first and second scattered lights generated by a scatter of the first and second pulses off of the given surface.

4. The apparatus of claim 1, wherein the determined status is a defect in the given surface.

5. The apparatus of claim 4, wherein the defect is at least one of a scratch, a dent and a foreign particle.

6. The apparatus of claim 1, wherein the first and second pulses irradiate a given inspecting position on the given surface.

7. The apparatus of claim 1, wherein the pulse irradiating part includes a pulse generating part generating a first pulse sequence including the first pulse and a second pulse sequence including the second pulse and an incident angle control part adjusting a path for at least a portion of the first and second pulse sequences to irradiate the given surface.

8. The apparatus of claim 7, wherein the pulse generating part includes a beam source generating a beam, a splitter dividing the beam into a first beam having a first path and a second beam having a second, a first chopper sampling the first beam to generate the first pulse sequence and a second chopper sampling the second beam to generate the second pulse sequence.

9. The apparatus of claim 7, wherein the pulse generating part includes a pulse source generating a given pulse sequence and a splitter dividing the given pulse sequence into the first and second pulse sequences.

10. The apparatus of claim 7, wherein the pulse generating part includes a first beam source generating a first beam, a second beam source generating a second beam, a first chopper sampling the first beam to generate the first pulse sequence and a second chopper sampling the second beam to generate the second pulse sequence.

11. The apparatus of claim 1, wherein the first and second pulses pulse at a given period, the given period being longer than either of the first and second pulse durations.

12. The apparatus of claim 3, wherein the determining part includes a signal converting unit converting the first scattered light and the second scattered light into at least one electrical signal.

13. The apparatus of claim 12, wherein the determining part includes a time separation detecting unit analyzing the at least one electrical signal to determine the status of the given surface.

14. The apparatus of claim 13, wherein the time separation detecting unit analyzes the at least one electrical signal in a plurality of inspecting periods, each of the plurality of inspecting periods including a pair of first and second pulses.

15. The apparatus of claim 14, wherein the time separation detecting unit detects a defect if the pair of first and second have a scattering intensity exceeding at least one intensity threshold within a corresponding inspecting period.

16. The apparatus of claim 7, wherein the pulse generating part generates the first and second pulse sequences at a given period, where each pulse of the second pulse sequence is delayed from a previous pulse of the first pulse sequence with a time interval shorter than the given period.

17. A method of inspecting a surface, comprising:
irradiating a first pulse on a given surface for a first pulse duration and at a first incident angle;
irradiating a second pulse on the given surface for a second pulse duration and at a second incident angle; and
determining a status of the given surface based on the first and second pulses.

18. The method of claim 17, wherein the first and second pulses irradiate a given inspecting position on the given surface.

19. The method of claim 17, wherein at least one of the first and second incident angles is an acute angle.

20. The method of claim 17, wherein at least one of the first and second incident angles approximates a right angle.

21. The method of claim 17, wherein the determining determines the status based on light scattered from the first and second pulses off of the given surface.

22. The method of claim 21, wherein the determining determines the status by converting the light scattered from the first and second pulses into at least one electrical signal and analyzing the at least one electrical signal.

23. The method of claim 22, wherein the analysis of the at least one electrical signal includes a time separating detecting method.

24. The method of claim 22, wherein the analysis of the at least one electrical signal includes a visual analysis by a user of a display of the at least one electrical signal.

25. The method of claim 17, wherein the given surface is a thin film on a semiconductor substrate.

26. The method of claim 17, wherein at least one of the first and second pulses is a laser pulse.

27. The method of claim 17, wherein the first and second pulse sequences include first and second pulses alternating at a given period.

28. The method of claim 27, wherein the given period is longer than either of the first and second pulse durations.

29. The method of claim 17, wherein the determined status is a defect in the given surface.

30. A method of inspecting a surface, comprising:
generating first and second pulse sequences including non-overlapping pulses; and
adjusting a path of at least a portion of one of the first and second pulse sequences such that each of the first and second pulse sequences are incident upon a given surface at different incident angles.

31. The method of claim 30, wherein the first and second pulse sequences include laser pulses.

32. The method of claim 30, wherein the first and second pulse sequences are incident upon a given inspecting position of the given surface.

33. The method of claim 30, wherein the different incident angles include at least one acute angle.

34. The method of claim 30, wherein the different incident angles include at least one angle approximating a right angle.

35. An apparatus for performing the method of claim 17.

36. An apparatus for performing the method of claim 30.
